(19) United States
(12) Patent Application Publication
(10) Pub. No.: US 2010/0247782 A1
(43) Pub. Date: Sep. 30, 2010

(54) METHOD OF PRODUCING INKJET RECORDING MEDIUM

(75) Inventor: Hideki KAIMOTO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/727,289

(22) Filed: Mar. 19, 2010

(30) Foreign Application Priority Data
Mar. 24, 2009 (JP) 2009-071787

(51) Int. Cl. B05D 3/02

(52) U.S. Cl. 427/379

(57) ABSTRACT

A method of producing an inkjet recording medium includes forming an ink receiving layer, wherein the forming of an ink receiving layer includes: forming a coating layer by applying at least one first coating liquid including inorganic particles and a water-soluble resin onto a substrate; and applying a second coating liquid including a polyvinyl alcohol in an amount of 50% by mass or less with respect to the polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol.

### CROSS-REFERENCE TO RELATED APPLICATION

This Application claims priority under 35 USC 119 from Japanese Patent Application No. 2009-071787 filed on Mar. 24, 2009, the disclosure of which is incorporated by reference herein.

### BACKGROUND OF THE INVENTION

1. Field of Invention

The present invention relates to a method of producing an inkjet recording medium.

2. Description of the Related Art

With recent rapid advances in the information technology industry, various information-processing systems have been developed, and recording techniques and apparatuses which are suitable for the information-processing systems have been put to practical use.

Among these recording techniques, inkjet recording methods have been widely used in homes as well as in offices because the inkjet recording methods have the advantages that they enable recording on various recording materials on which an image or the like is to be recorded, hardware (i.e., apparatuses) for the inkjet recording is relatively inexpensive and space-saving, little noise is made, and the like.

Recently, owing to attainment of high-resolution inkjet printers, “photograph-like” high-quality recorded images can be obtained. Together with these advances in hardware (apparatuses), various inkjet recording media have been developed.

In general, inkjet recording media are required to have characteristics including: (1) quick-drying property (i.e., high absorption speed of ink), (2) an adequate and uniform dot diameter of ink dots (free from bleeding), (3) excellent granularity, (4) high dot sphericity, (5) high color density, (6) high color saturation (no dullness), (7) excellent light resistance, gas resistance and water resistance of an image portion, (8) high whiteness of recording surfaces, (9) high storage stability (free from yellowing and bleeding of an image during long-term storage; bleeding over time is ameliorated), (10) resistance to deformation; that is, high dimensional stability (low curling) and (11) excellent conveyance properties through hardware.

Furthermore, when an inkjet recording medium is used as gloss photo paper that is used for obtaining a “photograph-like” high-quality recorded image, the inkjet recording medium is required to have glossiness, surface smoothness, and a texture like developing paper similar to that of silver halide photography, in addition to the above characteristics.

An example of an inkjet recording medium satisfying the above characteristics is an inkjet recording material which has at least two ink receiving layers, in which the ratio between the amount of inorganic particles such as vapor-phase process silica and the amount of a water-soluble resin such as polyvinyl alcohol (PVA) in an upper layer is different from that of a lower layer (see, for example, Japanese Patent Application Laid-Open (JP-A) No. 2002-36715).

Also, an inkjet recording sheet is known which has an ink receiving layer formed by applying a coating liquid containing an organic mordant onto a coating layer containing inorganic particles and a water-soluble resin (see, for example, JP-A No. 2002-274024).

### SUMMARY OF THE INVENTION

The present invention has been made in view of the above circumstances and provides a method of producing an inkjet recording medium.

According to a first aspect of the invention, there is provided a method of producing an inkjet recording medium. The method includes forming an ink receiving layer, wherein the forming of an ink receiving layer includes: forming a coating layer by applying at least one first coating liquid including inorganic particles and a water-soluble resin onto a substrate; and applying a second coating liquid including a polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol.

### DETAILED DESCRIPTION OF THE INVENTION

The inkjet recording media disclosed in JP-A Nos. 2002-36715 and 2002-274024 are not satisfactory from the viewpoints of scratch resistance of the ink receiving layer and print density.

A method of producing an inkjet recording medium in the invention is a method of producing an inkjet recording medium having, on a substrate, at least one ink receiving layer. The method includes ink receiving layer formation process whereby at least one ink receiving layer is formed on a substrate. In the invention, the ink receiving layer formation process includes forming a coating layer by applying at least one first coating liquid which contains inorganic particles and a water-soluble resin onto a substrate; and applying a second coating liquid which contains a polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol. The inkjet recording medium having the ink receiving layer formed in the ink receiving formation process has improved scratch resistance and higher gloss, as well as capability of realizing a high print density.

Ink Receiving Layer Formation Process

The ink receiving layer formation process according to the invention includes: forming a coating layer by applying at least one kind of first coating liquid including inorganic particles and a water-soluble resin onto a substrate; and applying a second coating liquid including a polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol.

In the coating layer formation process, at least one kind of first coating liquid which includes inorganic particles and a water-soluble resin is applied onto a substrate to form a coating layer. In the invention, the coating layer for forming the ink receiving layer may have only one layer, or may have at least two layers formed by applying at least two kinds of first coating liquid.

When the coating layer has at least two layers, the coating layer may be formed by sequential application of at least two kinds of first coating liquid, or may be formed by multilayer coating of at least two kinds of first coating liquid. In the invention, from the viewpoint of ink absorbency, the coating layer preferably has at least two layers, which are and more preferably formed by multilayer coating.

First Inorganic Particle

The first coating liquid includes at least one kind of inorganic particles (hereinafter sometimes referred to as first inorganic particles). The inorganic particles serve to form a porous structure when the ink receiving layer is formed, and to improve ink absorbency.

In particular, the ratio in terms of solid content of the inorganic particles in the ink receiving layer is preferably 50% by mass or more, and more preferably more than 60% by mass, because a further preferable porous structure may be formed, and an inkjet recording medium having sufficient ink absorbency may be obtained. The ratio in terms of solid content of the inorganic particles in the ink receiving layer indicates the ratio of the inorganic particles with respect to the total amount of the components, other than water, in the formulation of the ink receiving layer.

Examples of the first inorganic particles include particles of silica, colloidal silica, titanium dioxide, barium sulfate, calcium silicate, zeolite, kaolinite, halloysite, mica, talc, calcium carbonate, magnesium carbonate, calcium sulfate, pseudoboehmite, zinc oxide, zinc hydroxide, alumina, aluminum silicate, calcium silicate, magnesium silicate, zirconium oxide, zirconium hydroxide, cerium oxide, lanthanum oxide, or yttrium oxide. Among these, from the viewpoint of forming a preferable porous structure, silica particles, colloidal silica, alumina particles, or pseudoboehmite is preferable. The particles may be used in the state of primary particles, or in the state in which secondary particles are formed. The particles have an average primary particle diameter of preferably 2 μm or less, and more preferably 200 nm or less.

The first inorganic particles may more preferably be silica particles having an average primary particle diameter of 30 nm or less, colloidal silica having an average primary particle diameter of 30 nm or less, alumina particles having an average primary particle diameter of 20 nm or less, or pseudoboehmite having an average pore radius of from 2 nm to 15 nm, and particularly preferably be the silica particles, the alumina particles, or the pseudoboehmite.

In general, silica particles are roughly classified into wet process silica particles and dry process (vapor-phase process) silica particles depending on the production method thereof. In the wet process, a method of producing hydrous silica by forming active silica by acid decomposition of a silicate, polymerizing the active silica to a certain degree, and allowing the resultant polymerized product to aggregate and precipitate, is widely used. In the vapor-phase process, a method of producing anhydrous silica by high-temperature vapor-phase hydrolysis of a silicon halide (flame hydrolysis), or a method in which silica sand and coke are subjected to heat reduction and evaporation by arc in an electronic furnace and the resultant product is oxidized by air (arc process), is widely used. The “vapor-phase process silica” as used herein refers to anhydrous silica particles obtained by the vapor-phase processes. When silica particles are used in the invention, the silica particles are particularly preferably the vapor-phase process silica particles.

The vapor-phase process silica differs from the hydrous silica in density of silanol groups on the surface thereof, the presence or absence of pores, and the like, and exhibits different properties from those of the hydrous silica. The vapor-phase process silica is suitable for forming three-dimensional structures having high porosity, though the reason is not clear. It may be because, while the hydrous silica particles tend to closely aggregate (i.e., form aggregates) owing to high silanol densities of from 5 groups/nm² to 8 groups/nm² on the surface thereof, the vapor-phase process silica particles form loose aggregates (i.e., flocculates) owing to low silanol densities of from 2 groups/nm² to 3 groups/nm² on the particles surface, which results in formation of highly-porous structure.

The vapor-phase process silica has high absorption and retaining efficiencies of ink owing to its particularly high specific surface area. Meanwhile, since the vapor-phase process silica has a low refractive index, a transparent receiving layer can be provided when the vapor-phase process silica is dispersed to an appropriate particle diameter, and high color density and favorable color exhibiting properties can be provided. The transparency of the receiving layer is important for applications which require transparency such as OHP application, as well as for an application to a recording medium such as gloss photo paper, from the viewpoints of obtaining high color density and favorable color exhibiting properties and glossiness.

The vapor-phase process silica has an average primary particle diameter of preferably 30 nm or less, more preferably 20 nm or less, particularly preferably 10 nm or less, and most preferably from 3 nm to 10 nm. The vapor-phase process silica particles tend to adhere to each other via hydrogen bonding among the silanol groups. Therefore, the vapor-phase process silica can form a highly-porous structure when it has an average primary particle diameter of 30 nm or less, whereby ink absorbency can be effectively improved.

The first inorganic particles to be used in the invention are preferably vapor-phase silica particles that can be obtained by the dry process (i.e., anhydrous silica), and more preferably silica particles having a density of silanol groups at the surface thereof of from 2 to 3 groups/nm².

The silica particles which are most preferable in the invention are vapor-phase silica particles having a specific surface area according to the BET method of 200 m²/g or more.

The silica particles may be used in combination with other inorganic particles such as those described above. When the vapor-phase process silica particles are used in combination with other inorganic particles, the content of the vapor-phase process silica particles with respect to the total amount of inorganic particles is preferably 30% by mass or more, and more preferably 50% by mass or more.

Preferable examples of the first inorganic particles to be used in the invention further include alumina particles, particles of alumina hydrate, and a mixture or composite thereof. Among these, alumina hydrate particles are preferable since they efficiently absorb and fix an ink, and pseudoboehmite (Al₂O₃.nH₂O) is particularly preferable. Although various kinds of alumina hydrate may be used, it is preferable to use a boehmite sol as a material of the alumina hydrate because a flat and smooth layer can be easily formed.

Regarding pore structure of the pseudoboehmite, the pseudoboehmite has an average pore radius of preferably from 1 nm to 30 nm, and more preferably from 2 nm to 15 nm, and has a pore volume of preferably from 0.3 ml/g to 2.0 ml/g, and more preferably from 0.5 ml/g to 1.5 ml/g. Herein, the pore radius and pore volume may each be determined by the nitrogen adsorption/desorption method using, for example, a gas adsorption/desorption analyzer such as OMNISORP 369 (trade name, manufactured by Beckman Coulter, Inc.).

Among the alumina particles, vapor-phase process alumina particles are preferable since they have a large specific surface area. The vapor-phase process alumina particles have an average primary particle diameter of preferably 30 nm or less, and more preferably 20 nm or less.

When any of such particles are used for the inkjet recording medium, it is also preferable to use the particles in the embodiments as disclosed in, for example, JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

Water-Soluble Resin

The first coating liquid used in the invention includes at least one water-soluble resin. Examples of the water-soluble resin include: resins having a hydroxyl group as a hydrophilic structural unit, such as polyvinyl alcohol (PVA), cation-modified polyvinyl alcohol, anion-modified polyvinyl alcohol, silanol-modified polyvinyl alcohol, polyvinyl acetal, cellulose resins (e.g., methyl cellulose (MC), ethyl cellulose (EC), hydroxyethyl cellulose (HEC), carboxymethyl cellulose (CMC), and hydroxypropyl cellulose (HPC)), chitins, chitosans, and starch; resins having a hydrophilic ether bond, such as polyethylene oxide (PEO), polypropylene oxide (PPO), and polyvinyl ether (PVE); and resins having a hydrophilic amido group or amido bond, such as polyacrylamide (PAAM) and polyvinylpyrrolidone (PVP). Other examples thereof include polyacrylic acid salts, maleic acid resins, alginic acid salts, and gelatins, each of which has a carboxyl group as a dissociable group.

The water-soluble resin to be used in the invention is preferably a polyvinyl alcohol from the viewpoints of glossiness and ink absorbency. The polyvinyl alcohol has hydroxyl groups in structural units thereof, and hydrogen bonds are formed between these hydroxyl groups and silanol groups present on the surfaces of the silica particles, as a result of which a three-dimensional network structure having secondary particles of the silica particles as chain units is easily formed. It is thought that the formation of such a three-dimensional network structure allows the obtained ink receiving layer to have a porous structure with a high porosity.

When inkjet recording is performed, the porous ink receiving layer obtained as described above rapidly absorbs an ink through capillary action, and dots of high circularity without ink bleeding can be formed.

The saponification degree of the polyvinyl alcohol that may be used in the invention is not particularly limited, but may be from 80 mol % to 99.8 mol %, for example. In particular, from the viewpoints of ink absorbency and stability at formation of an ink receiving layer, the saponification degree is preferably from 92 mol % to 98 mol %, and more preferably from 93 mol % to 97 mol %.

The polymerization degree of the polyvinyl alcohol that may be used in the invention is not particularly limited, and may be from 300 to 4,500, for example. In particular, from the viewpoints of preventing cracking of the ink receiving layer and ensuring stability at formation of an ink receiving layer, the polymerization degree is preferably from 1,500 to 3,600, and more preferably from 2,000 to 3,500.

In the invention, as the water-soluble resin, one or more other water-soluble resins may be used, if necessary, in combination with the polyvinyl alcohol. When the polyvinyl alcohol and such additional water-soluble resins are used in combination, the proportion of the additional water-soluble resins is preferably from 1% by mass to 30% by mass, more preferably from 3% by mass to 20% by mass, and particularly preferably from 6% by mass to 12% by mass, with respect to the total amount of the polyvinyl alcohol and the additional water-soluble resins.

The amount of the water-soluble resin to be used in the invention is preferably from 9% by mass to 40% by mass, and more preferably from 12% by mass to 33% by mass, with respect to the total solid content of the ink receiving layer, from the viewpoints of preventing a decrease in film strength and cracking while drying, which are caused by an excessively low content of the water-soluble resin, and preventing a reduction in ink absorbency that results from decrease in porosity due to an increased tendency for pores to be clogged by the resin, which is caused by an excessively high content of the water-soluble resin.

Content Ratio of First Inorganic Particles to Water-Soluble Resin

In the invention, the content ratio by mass of the first inorganic particles (preferably silica particles) (x) to the water-soluble resin (y) (P/B ratio (x/y), the mass of the first inorganic particles with respect to 1 part by mass of water-soluble resin) in the entire ink receiving layer has a large influence on the film structure of the ink receiving layer. Specifically, a higher P/B ratio provides a higher porosity, a higher pore volume, and a larger surface area (per unit mass).

The P/B ratio (x/y) of the ink receiving layer is preferably in a range of from 1.5/1 to 10/1 from the viewpoints of preventing a decrease in film strength and the cracks while drying, which are caused by excessively high P/B ratios, and avoiding a reduction in ink absorbency that results from decrease in porosity due to a an increased tendency for pores to be clogged by the resins, which is caused by excessively low P/B ratios.

When passing through a conveyance system of an inkjet printer, the recording sheet may sometimes receive stress. Therefore, the ink receiving layer is required to have sufficient film strength. Moreover, the sufficient film strength of the ink receiving layer is required also from the viewpoint of preventing cracking, exfoliating, and the like of the ink receiving layer when the recording medium is cut into sheets. In view of the above, the P/B ratio (x/y) is preferably 5/1 or less, and, from the viewpoint of providing ability to rapidly absorb ink when the recording medium is used in an inkjet printer, the P/B ratio (x/y) is more preferably 2/1 or more.

For example, when a coating liquid prepared by completely dispersing anhydrous silica particles having an average primary particle diameter of 20 nm or less and a polyvinyl alcohol at a P/B ratio (x/y) of from 2/1 to 5/1 in a solution is applied onto a substrate and dried, a three-dimensional network structure having secondary particles of the silica particles as network chains is formed, whereby a light-transmitting porous film having an average pore diameter of 30 nm or less, a porosity of from 50% to 80%, a specific pore volume of 0.5 ml/g or more, and a specific surface area of 100 m²/g or more can be easily formed.

Crosslinking Agent

The first coating liquid to be used in the invention preferably includes a crosslinking agent from the viewpoints of ink receiving layer strength. In a preferable embodiment of the invention, the ink receiving layer is a porous layer that has been cured by a crosslinking reaction of the water-soluble resins with the crosslinking agent.

As the crosslinking agent, a crosslinking agent which is preferable in relation to the water-soluble resin included in the first coating liquid may be appropriately selected. For example, when a polyvinyl alcohol is used as a water-soluble resin, boron compounds are preferable from the viewpoint of rapidness of crosslinking reaction. Examples thereof include borax, boric acid, borates (such as orthoborate, InBO₃, ScBO₃, YBO₃, LaBO₃, Mg₃(BO₃)₂ or CO₃(BO₃)₂), diborates (such as Mg₂B₂O₅ or CO₂B₂O₅), metaborates (such as LiBO₂, Ca(BO₂)₂, NaBO₂, or KBO₂), tetraborates (such as Na₂B₄O₇.10H₂O), pentaborates (such as KB₅O₈.4H₂O or CsB₅O₅) and hexaborates (such as Ca₂B₆O₁₁₀.7H₂O). Among these, from the viewpoint of rapidness of crosslinking reaction, borax, boric acid, and borates are preferable, boric acid and borates are particularly preferable, and it is most preferable to use a combination of the crosslinking agent with a polyvinyl alcohol as a water-soluble resin.

In the invention, the amount of the contained crosslinking agent is, for example, preferably from 0.05 parts by mass to 0.50 parts by mass, and more preferably from 0.08 parts by mass to 0.30 parts by mass, with respect to 1.0 parts of polyvinyl alcohol. When the amount of the contained crosslinking agent is within the above range, the polyvinyl alcohol is efficiently crosslinked, whereby cracking and the like are prevented.

When a gelatin is used as a water-soluble resin, other crosslinking agents than the boron compounds may be used, such as those described below.

Examples of other crosslinking agents include aldehyde compounds, such as formaldehyde, glyoxal and glutaraldehyde; ketone compounds, such as diacetyl and cyclopentanedione; active halogen compounds, such as bis(2-chloroethylurea)-2-hydroxy-4,6-dichloro-1,3,5-triazine and sodium salt of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins;

isocyanate compounds, such as 1,6-hexamethylene diisocyanate; the aziridine compounds such as those described in U.S. Pat. Nos. 3,017,280 and 2,983,611; the carboxylamide compounds such as those described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate and chromium acetate; polyamine compounds, such as tetraethylenepentamine; hydrazide compounds, such as adipic acid dihydrazide; low-molecular compounds having at least two oxazoline groups; and polymers having at least two oxazoline groups. The crosslinking agent may be used singly, or two or more thereof may be used in combination.

Water-Soluble Aluminum Compound

The first coating liquid to be used in the invention preferably includes a water-soluble aluminum compound. By using the water-soluble aluminum compound, water resistance of a formed image can be improved, and bleeding over time of the formed image can be ameliorated.

Examples of the water-soluble aluminum compound include an inorganic salt such as aluminum chloride or a hydrate thereof, aluminum sulfate or a hydrate thereof, or ammonium alum; and a basic polyaluminum hydroxide compound which is an inorganic aluminum-containing cationic polymer. Among these, a basic polyaluminum hydroxide compound is preferable.

The term “basic polyaluminum hydroxide compound” described above refers to a water-soluble polyaluminum hydroxide of which main component is represented by the following Formula (1), (2), or (3), and which stably contains a basic polymeric polynuclear condensed ion, such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ 5<m<80, 1<n<5 Formula (1)

[Al(OH)₃]ₙAlCl₃ 1<n<2 Formula (2)

Alₙ(OH)ₘCl₍₃ₙ₋ₘ₎ 0<m<3n, 5<m<8 Formula (3)

The polyaluminum hydroxide compounds are commercially available, and examples thereof include polyaluminum chloride (PAC) as a water treatment agent available from Taki Chemical Co., Ltd., polyaluminum hydroxide (Paho) available from Asada Chemical Industry Co., Ltd., PYURAKEMU WT available from Rikengreen Co., Ltd., ALFINE 83 available from Taimei Chemicals Co., Ltd., and products for similar applications available from other manufacturers. Products of various grades are readily available. In the invention, any of these commercially-available products may be used without modification. However, some products have pH values that are too low to be suitably used; therefore, when a product has an excessively low pH, the product can be used after the pH thereof is appropriately adjusted.

The amount of the water-soluble aluminum compound included in the ink receiving layer is preferably from 0.1% by mass to 20% by mass, more preferably from 1% by mass to 8% by mass, and most preferably from 2% by mass to 4% by mass, with respect to the total solid content of the ink receiving layer. When the amount of the contained water-soluble aluminum compound is within the range of from 0.1% by mass to 20% by mass, glossiness, water resistance, gas resistance, and light resistance can be improved.

Zirconium Compound

The first coating liquid in the invention preferably includes a zirconium compound. Use of the zirconium compound efficiently improves water resistance.

The zirconium compound that may be used in the invention is not particularly limited, and various zirconium compounds may be used. Examples thereof include zirconyl acetate, zirconium chloride, zirconium oxychloride, zirconyl hydroxychloride, zirconyl nitrate, basic zirconyl carbonate, zirconyl hydroxide, ammonium zirconyl carbonate, potassium zirconyl carbonate, zirconyl sulfate, and zirconyl fluoride compounds. Among these, zirconyl acetate is particularly preferable.

The amount of the zirconium compound in the ink receiving layer of the invention is preferably from 0.05% by mass to 5.0% by mass, more preferably from 0.1% by mass to 3.0% by mass, and particularly preferably from 0.5% by mass to 2.0% by mass, with respect to the total solid content of the ink receiving layer. When the amount of the zirconium compound is within the range of from 0.05% by mass to 5.0% by mass, water resistance can be improved without deteriorating ink absorbency.

In the invention, water-soluble polyvalent metal salts, other than the water-soluble aluminum compound and the zirconium compound, may be used. Examples of the other water-soluble polyvalent metal compounds include water-soluble salts of metals selected from the group consisting of calcium, barium, manganese, copper, cobalt, nickel, iron, zinc, chromium, magnesium, tungsten, and molybdenum.

Specific examples thereof include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate nonahydrate, sodium phosphotungstate, tungsten sodium citrate, 12-tungstophosphate n-hydrate, 12-tungstosilicate 26-hydrate, molybdenum chloride, and 12-molybdophosphate n-hydrate.

Other Components

The first coating liquid to be used in the invention may include an additional component other than those described above, as necessary. For example, the first coating liquid may include a discoloration inhibitor in order to prevent deterioration of ink color materials, and examples thereof include various ultraviolet absorbers, antioxidants, and singlet oxygen quenchers.

Specific examples thereof include the substances disclosed in paragraphs [0088] to of JP-A No. 2005-14593 and the substances disclosed in paragraphs [0138] to [0155] of JP-A No. 2006-321176, and any of these substances may be appropriately selected and used.

The first coating liquid to be used in the invention preferably includes a high-boiling organic solvent in order to prevent curling. The high-boiling organic solvent is preferably water-soluble. Examples of water-soluble high-boiling organic solvents include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (having a weight average molecular weight of 400 or less). The water-soluble high-boiling organic solvent is preferably diethylene glycol monobutyl ether (DEGMBE).

The amount of the high-boiling organic solvent in the first coating liquid is preferably from 0.05% by mass to 1% by mass, and particularly preferably from 0.1% by mass to 0.6% by mass.

The first coating liquid may include an inorganic salt and/or a pH adjuster such as an acid or an alkali, in order to improve dispersibility of the inorganic particles.

Furthermore, the first coating liquid may include metal oxide particles having electroconductivity, which serve to suppress electrification of the surface of the ink receiving layer due to friction or separation, and/or a matt agent, which serves to reduce friction at the surface of the ink receiving layer.

When the coating layer is formed by the application of at least two kinds of first coating liquids in the coating layer formation process, the at least two kinds of first coating liquids have different configurations from one another, and the difference in configurations therebetween is not particularly limited. In the invention, from the viewpoints of ink absorbency and print density, it is preferable that the at least two kinds of first coating liquids are different from each other in the ratio of the first inorganic particles to the water-soluble resin (P/B ratio). It is more preferable that the P/B ratio in the first coating liquid to be applied at a position farthest from the substrate is larger than the P/B ratio in the first coating liquid to be applied at a position closer to the substrate. In particular, the P/B ratio in the first coating liquid to be applied at a position farthest from the substrate is larger by preferably from 1 to 20, and more preferably from 2 to 10, than the P/B ratio in the first coating liquid to be applied at a position closer to the substrate.

When the difference in P/B ratio is 1 or more, the print density can be effectively improved. Meanwhile, when the difference in P/B ratio is 20 or less, the amount of the water-soluble resin in the coating liquid to be applied at a position farthest from the substrate is prevented from becoming too small, and a decrease in glossiness can be suppressed.

Provided that the total thickness of the ink receiving layer is regarded as 100%, the thickness of the uppermost layer formed from the first coating liquid applied at a position farthest from the substrate is preferably from 5% to 50%, and more preferably from 10% to 30%, with respect to the total thickness of the ink receiving layer, from the viewpoints of glossiness and prevention of cracking at coating and drying. The thickness of the uppermost layer may appropriately be changed in accordance with the P/B ratio thereof.

The first coating liquid in the invention may be prepared, for example, in the following manner. Silica particles and, optionally, a zirconium compound are dispersed by counter collision using a high-pressure dispersion apparatus or by allowing them to pass through an orifice, so as to prepare a silica particle dispersion liquid, and then the water-soluble resin is added thereto.

The dispersion liquid prepared by counter collision of silica particles using a high-pressure dispersion apparatus or by allowing the silica particles to pass through an orifice is preferable because inorganic particles having smaller particle diameters can be obtained.

The silica particles are processed by the high-pressure dispersion apparatus in a form of a dispersion liquid (i.e., predispersion). A premixing treatment (or predispersion treatment) may be carried out by general propeller agitation, turbine agitation, homomixer agitation, or the like.

The high-pressure dispersion apparatus that may be used in the preparation of the silica particle dispersion liquid may be suitably selected from commercially-available apparatus which are generally called “high-pressure homogenizer”.

Representative examples of the high-pressure homogenizer include NANOMIZER (trade name, manufactured by NANOMIZER Inc.), MICROFLUIDIZER (registered trade name, manufactured by Microfluidics Corp.), and ULTIMIZER (trade name, manufactured by Sugino Machine Ltd.).

The “orifice” refers to a mechanism in which a thin plate (i.e., orifice plate) having a fine hole of circular shape or the like is placed in a straight pipe so that the flow channel in the straight pipe abruptly narrows at the fine hole.

The high-pressure homogenizer basically has a high-pressure generation unit that applies a pressure to a raw slurry or the like, and a counter collision unit or an orifice unit. As the high-pressure generation unit, a high-pressure pump generally called “plunger pump” is preferably used. High-pressure pumps are classified into various kinds, including single, double, and triple pumps, and any of these may be used in the invention without particular limitation.

When the counter collision at high pressure is performed, the process pressure may be 50 MPa or more, preferably 100 MPa or more, and more preferably 130 MPa or more.

When the dispersing is performed by passing through an orifice, the difference between the pressure at an entrance and the pressure at an exit of the orifice may be, similar to the above process pressure, 50 MPa or more, preferably 100 MPa or more, and more preferably 130 MPa or more.

When the predispersion liquid is subjected to counter collision, the collision speed as a relative speed is preferably 50 msec or more, more preferably 100 msec or more, and particularly preferably 150 msec or more.

The linear speed of the solvent when passing through the orifice cannot be determined unconditionally because the linear speed is determined depending on the diameter of the orifice to be used. However, the linear speed is, similar to the collision speed of the counter collision, preferably 50 msec or more, more preferably 100 msec or more, and particularly preferably 150 msec or more.

In either method, the dispersion efficiency depends on the process pressure; therefore, a higher process pressure leads to a higher dispersion efficiency. However, when the process pressure exceeds 350 MPa, problems tend to occur in pressure resistance of the piping and the like of the high-pressure pump and in durability of the apparatus.

In either method, the number of times the treatment is performed is not particularly limited, and is appropriately selected from a range of, generally, from once to several tens of times. As a result, a dispersion liquid can be obtained.

In the preparation of the dispersion liquid, various additives may be added to the dispersion liquid.

Examples of the additives include various nonionic or cationic surfactants (anionic surfactants are unpreferred due to formation of aggregates), defoaming agents, nonionic hydrophilic polymers (such as a polyvinyl alcohol, polyvinylpyrrolidone, polyethylene oxide, polyacrylamide, various saccharides, gelatin, or pullulan), nonionic or cationic latex dispersion liquids, water-miscible organic solvents (such as ethyl acetate, methanol, ethanol, isopropanol, n-propanol, or acetone), inorganic salts, and pH adjusters, and any of these may be appropriately used as necessary.

In particular, use of a water-miscible organic solvent is preferable because generation of minute lumps is prevented when predispersing the silica particles. The water-miscible organic solvent may be used at a content of from 0.1% by mass to 20% by mass, and particularly preferably from 0.5% by mass to 10% by mass, in the dispersion liquid.

The pH at the preparation of the silica particle dispersion liquid may widely vary depending on the kind of the silica particles or the additives. In general, the pH is from 1 to 8, and particularly preferably from 2 to 7. In an embodiment, two or more additives are added when dispersing is performed as described above.

A water-soluble resin or the like is added to the thus-obtained silica particle dispersion liquid, whereby a first coating liquid (coating liquid for forming an ink receiving layer) is obtained. The silica particle dispersion liquid and the water-soluble resin, and other ingredients if any, may be mixed by general propeller agitation, turbine agitation, homomixer agitation, or the like.

In the invention, the first coating liquid and the water-soluble aluminum compound may be mixed by in-line mixing. Examples of in-line mixing apparatuses that may used in the in-line mixing include, but not particularly limited, those disclosed in JP-A No. 2002-85948.

The first coating liquid may be prepared using, as a solvent, water, an organic solvent, or a mixture thereof. Examples of the organic solvent include alcohols such as methanol, ethanol, n-propanol, i-propanol, or methoxypropanol, ketones such as acetone or methyl ethyl ketone, tetrahydrofuran, acetonitrile, ethyl acetate, and toluene.

Coating of the first coating liquid can be performed by a known coating method using an apparatus such as an extrusion die coater, an air doctor coater, a blade coater, a rod coater, a knife coater, a squeeze coater, a reverse roll coater, or a bar coater.

The ink receiving layer formation process in the invention includes applying, onto a coating layer formed by application of the first coating liquid onto a substrate, a second coating liquid including a polyvinyl alcohol and inorganic particles whose amount is 50% by mass or less with respect to the polyvinyl alcohol, either (1) at the same time as the application of the first coating liquid or (2) during drying of the coating layer but before the coating layer exhibits falling-rate drying. Inclusion of the polyvinyl alcohol in the second coating liquid improves scratch resistance and ink absorbency of the ink receiving layer, realizes high print density, and, furthermore, achieves a high glossiness.

The second coating liquid to be used in the invention is not particularly limited as long as it includes at least one polyvinyl alcohol, and the amount of the inorganic particles included in the second coating liquid (hereinafter sometimes referred to as second inorganic particles) is 50% by mass or less with respect to the polyvinyl alcohol. In the invention, the second coating liquid is preferably a basic solution having a pH of 7.1 or higher, from the viewpoints of ink absorbency and crack prevention of the ink receiving layer. When an alkaline solution is used as the second coating liquid, curing of the layer can be accelerated. The second coating liquid has pH of more preferably 7.5 or higher, and particularly preferably 7.9 or higher. When the pH is 7.1 or higher, crosslinking reaction of the water-soluble resin (such as polyvinyl alcohol) included in the first coating liquid caused by the crosslinking agent is sufficiently promoted, and generation of bronzing, cracking in the ink receiving layer, and the like are effectively prevented.

The pH of the second coating liquid may be adjusted to a desired pH by, for example, incorporating a basic compound into the second coating liquid. The basic compound is not particularly limited, and generally-used compounds may be used. The basic compound may be an organic base or an inorganic base.

Moreover, the second coating liquid may further include a crosslinking agent or the like as necessary.

The second coating liquid includes at least one polyvinyl alcohol. Examples of the polyvinyl alcohol to be included in the second coating liquid include the above-described polyvinyl alcohols that can be used in the first coating liquid. In the invention, from the viewpoints of ink absorbency and print density, the polyvinyl alcohol to be used in the second coating liquid has a polymerization degree of preferably from 1,000 to 3,500, and more preferably from 1,500 to 2,400. In addition, from the viewpoints of ink absorbency and print density, the polyvinyl alcohol to be used in the second coating liquid has a saponification degree of preferably from 88 to 99%, and more preferably from 88 to 95%.

The polyvinyl alcohol in the second coating liquid may be selected from various modified PVAs. In particular, a silanol-modified PVA is preferably used from the viewpoint of improving scratch resistance.

It is desirable that the amount of the polyvinyl alcohol contained in the second coating liquid is appropriately adjusted depending on the coating method. However, the amount may be from 0.02% by mass to 5% by mass, preferably from 0.05% by mass to 2% by mass, and more preferably from 0.05% by mass to 0.5% by mass.

In the second coating liquid to be used in the invention, the amount of inorganic particles is 50% by mass or less with respect to the polyvinyl alcohol. From the viewpoints of scratch resistance, print density, and glossiness, the amount is preferably 20% by mass or less, and it is more preferable that the second coating liquid is substantially free from inorganic particles. When the amount of inorganic particles in the second coating liquid exceeds 50% by mass with respect to the polyvinyl alcohol, scratch resistance and glossiness may sometimes decrease.

The definition of the inorganic particles that may be included in the second coating liquid may be the same as that of the first inorganic particles included in the first coating liquid, and preferable embodiments thereof are also the same.

The second coating liquid may be prepared, for example, as follows. A polyvinyl alcohol and a basic compound (in an amount of, for example, from 1% to 5%) and, optionally, a crosslinking agent (for example, a boron compound) and/or a metal compound (in an amount of, for example, from 1% to 5%), are added to ion-exchange water, and the resultant mixture liquid is sufficiently agitated. Here, “%” as used for respective components refers to % by mass in terms of solid content.

In the invention, application of the second coating liquid onto the coating layer formed through the coating layer formation process is performed either (1) at the same time as the application of the first coating liquid or (2) during drying of the coating layer but before the coating layer exhibits falling-rate drying.

The expression “before the coating layer exhibits falling-rate drying” usually refers to a period of several minutes from immediately after the application of the first coating liquid, and during this period, the applied coating layer shows the phenomenon of “constant-rate drying” in which the solvent (dispersion medium) content in the coating layer decreases in proportion to the lapse of time. In regard to the time for such “constant-rate drying”, descriptions in Kagaku Kogaku Binran (Handbook of Chemical Technology), pages 707-712, MARUZEN Co., Ltd. (Oct. 25, 1980) may be referenced.

The conditions in which the coating layer is dried, after application of the first coating liquid, until the coating layer comes to exhibit falling-rate drying are generally chosen from the drying temperature range of from 40° C. to 180° C. and the drying time range of from 0.5 minutes to 10 minutes (preferably from 0.5 minutes to 5 minutes). Although the drying time naturally varies according to the coating amount, the range specified above is usually appropriate.

The second coating liquid may be applied by a method in which the second coating liquid is applied by coating onto a coating layer formed from the first coating liquid, a method in which the second coating liquid is applied by spraying or the like onto the coating layer, a method in which a substrate on which the coating layer has been formed is immersed in the second coating liquid, or the like.

When the second coating liquid is applied by coating, the coating method may be selected from the coating methods that can be used for coating the first coating liquid. However, it is preferable to select a method in which the coater does not directly contact the coating layer which has been formed from the first coating liquid.

In the invention, regarding the amount of the second coating liquid to be applied, the amount of the polyvinyl alcohol to be applied is preferably from 0.002 g/m² to 0.1 g/m², and more preferably from 0.005 g/m² to 0.05 g/m², from the viewpoints of scratch resistance, ink absorbency, print density, and glossiness of the ink receiving layer.

After the application of the second coating liquid, drying and curing are performed by heating generally at from 40° C. to 180° C. for from 0.5 minutes to 30 minutes, and particularly preferably at from 40° C. to 150° C. for from 1 minute to 20 minutes. For example, when the second coating liquid includes, as a boron compound, borax or boric acid, it is preferable to perform heating at from 60° C. to 100° C. for from 0.5 minutes to 15 minutes.

Alternatively, the second coating liquid may be applied at the same time as the application of the first coating liquid. In this case, the first and second coating liquids may be simultaneously applied (i.e., subjected to multilayer coating) onto a substrate in such a manner that the first coating liquid is in contact with the substrate, and then dried and cured, whereby an ink receiving layer is formed.

The simultaneous coating (i.e., multilayer coating) may be performed by, for example, a coating method using an extrusion die coater or a curtain flow coater. After the simultaneous coating, the formed coating layers may be dried. The drying is generally performed in such a manner that the coating layers are heated at from 40° C. to 150° C. for from 0.5 minutes to 10 minutes, and more preferably at from 40° C. to 100° C. for from 0.5 minutes to 5 minutes. For example, when borax or boric acid is used as a crosslinking agent contained in the second coating liquid, the heating is preferably performed at from 60° C. to 100° C. for from 5 minutes to 20 minutes.

Substrate

The substrate to be used in the invention may be a transparent substrate formed from a transparent material such as plastic or an opaque substrate formed from an opaque material such as paper. Specific examples thereof include the substrates disclosed in paragraphs [0139] to [0155] and the like of JP-A No. 2008-246988. Among these, polyethylene-coated paper is preferable.

### EXAMPLES

In the following, the present invention is described in further detail with reference to examples; however, the present invention is not in any way limited to these Examples. Moreover, the terms “part” and “%” are in accordance with a mass standard unless indicated otherwise.

### Example 1

### Preparation of Substrate

A mixture of 50 parts of leaf bleached kraft pulp (LBKP) of acacia and 50 parts of aspen LBKP was beaten to a Canadian Standard Freeness of 300 ml using a disk refiner, to prepare a pulp slurry.

To this pulp slurry, 1.3% of cationic starch (CAT0304L, trade name, manufactured by Nippon NSC Ltd.), 0.15% of an anionic polyacrylamide (POLYACRON ST-13, trade name, manufactured by Seiko PMC Corporation), 0.29% of an alkyl ketene dimer (SIZEPINE K, trade name, manufactured by Arakawa Chemical Industries, Ltd.), 0.29% of epoxidized behenamide, and 0.32% of polyamide-polyamine-epichlorohydrin (ARAFIX 100, trade name, manufactured by Arakawa Chemical Industries, Ltd.), the respective percentages being based on the mass of the pulp, were added, and then 0.12% of a defoaming agent was added thereto.

The thus-prepared pulp slurry was processed into paper using a fourdrinier paper machine. The paper was dried in such a manner that the felt surface of the web was pressed against a drum drier cylinder via a drier canvas while the tension of the drier canvas was set to 1.6 Kg/cm. Thereafter, 1 g/m² of a polyvinyl alcohol (KL-118, trade name, manufactured by Kuraray Co., Ltd.) was applied by size press onto both surfaces of the base paper and dried, followed by a calendar treatment. The obtained base paper (substrate paper) had a basis weight of 157 g/m² and a thickness of 157 μm.

The wire surface (i.e., rear surface) of the thus-obtained substrate paper was subjected to a corona discharge treatment, and then a blend of a high-density polyethylene and a low-density polyethylene at a proportion (high-density polyethylene/low-density polyethylene) of 80%/20% in an amount of 20 g/m² was applied by extrusion using a melt extruder at 320° C., whereby a thermoplastic resin layer having a matt surface was formed. Hereinafter, the side having the thermoplastic resin layer is referred to as “rear surface”. The thermoplastic resin layer at the rear surface was further subjected to a corona discharge treatment, and then coated with a dispersion liquid obtained by dispersing aluminum oxide (ALUMINASOL 100 (trade name) manufactured by Nissan Chemical Industries, Ltd.) and silicon dioxide (SNOWTEX O (registered trademark) manufactured by Nissan Chemical Industries, Ltd.) as antistatic agents in a mass ratio (aluminum oxide:silicon dioxide) of 1:2 in water, so that the dry weight of the dispersion was 0.2 g/m². Subsequently, the front surface of the substrate paper was subjected to a corona discharge treatment, and then a polyethylene containing 10% by mass of titanium oxide and having a density of 0.93 g/m² in an amount of 24 g/m² was applied by extrusion using a melt extruder at 320° C.

Preparation of First Coating Liquid A

In accordance with the following composition of “silica dispersion liquid A”, silica particles, ion-exchange water, a diallyl dimethyl ammonium chloride polymer (SHALLOL DC902P, trade name, manufactured by Dai-ichi Kogyo Seiyaku Co., Ltd.), and zirconyl acetate were mixed and dispersed using a liquid-liquid collision disperser (ULTIMIZER (trade name), manufactured by Sugino Machine Ltd.). The resultant dispersion liquid was heated to 45° C., and retained for 20 hours, thereby preparing a silica dispersion liquid A.

To 45.7 parts of the thus-obtained silica dispersion liquid A, 26 parts of a polyvinyl alcohol (i.e., water-soluble resin) solution A having the following composition, 0.33 parts of boric acid, and 20 parts of ion-exchange water were added at 30° C., thereby preparing a first coating liquid A for ink receiving layer formation.

The mass ratio of the silica particles to the water-soluble resin in the first coating liquid A (P/B ratio=silica particles/water-soluble resin) was 4.9.

“Silica dispersion liquid A”

| | | |
|---|---|---|
| (1) | Silica particles (AEROSIL (registered trademark) | 19.5 parts |
| | 300SF75, manufactured by Nippon Aerosil Co., Ltd.) | |
| (2) | Ion-exchange water | 77.7 parts |
| (3) | SHALLOL DC-902P (51.5% solution) (dispersant; | 1.7 parts |
| | manufactured by Dai-ichi Kogyo Seiyaku Co., Ltd.) | |
| (4) | Zirconyl acetate (50% solution) (ZIRCOSOL ZA-30, | 1.1 parts |
| | trade name, manufactured by Daiichi Kigenso | |
| | Kagaku Kogyo Co., Ltd.) | |

“Polyvinyl alcohol (water-soluble resin) solution A”

| | | |
|---|---|---|
| (1) | Polyvinyl alcohol (JM-33, trade name, manufactured | 7 parts |
| | by JAPAN VAM & POVAL CO., LTD.; saponification | |
| | degree: 94.3 mol %; polymerization degree: 3,300) | |
| (2) | Ion-exchange water | 91.2 parts |
| (3) | Diethylene glycol monobutyl ether (BUTYCENOL | 2.1 parts |
| | 20P, trade name, manufactured by Kyowa Hakko | |
| | Chemical Co., Ltd.) | |
| (4) | Polyoxyethylene lauryl ether (EMULGEN 109P, | 0.02 parts |
| | trade name, manufactured by Kao Corporation) | |

Preparation of Second Coating Liquid E

Respective components were mixed in accordance with the following composition of “second coating liquid E” to prepare a second coating liquid E.

“Second coating liquid E”

| | | |
|---|---|---|
| (1) | Polyvinyl alcohol (PVA217, trade name, manufactured | 0.1 parts |
| | by Kuraray Co., Ltd.; saponification degree: from | |
| | 87 to 89%; polymerization degree: 1,700) | |
| (2) | Ammonium carbonate (first grade, manufactured by | 5.0 parts |
| | Kanto Kagaku) | |
| (3) | Ion-exchange water | 88.9 parts |
| (4) | Polyoxyethylene lauryl ether (10% aqueous solution, | 6.0 parts |
| | EMULGEN 109P, trade name, manufactured by Kao | |
| | Corporation; HLB value: 13.6) | |

Production of Inkjet Recording Medium

The front surface of the substrate was subjected to a corona discharge treatment. Then, the coating liquid A for ink receiving layer formation and the following in-line liquid A were subjected to in-line mixing and the resultant liquid was applied onto the front surface using an extrusion die coater, such that the coating amount of the coating liquid A was 190 ml/m² and the coating amount of the in-line liquid A was 11.4 ml/m², thereby forming a coating layer.

The thus-formed coating layer was dried using a hot air drier (at a wind speed of from 3 msec to 8 msec) at 90° C. (dew-point temperature of 5° C.) so that the solid content concentration of the coating layer became 17%. Subsequently, the coating layer was dried (at a wind speed of from 3 msec to 8 msec) at 55° C. (dew-point temperature of 5° C.) so that the solid content concentration of the coating layer became 24%. During these processes, the drying rate of the coating layer was constant (the coating layer showed the phenomenon of constant-rate drying).

Immediately thereafter, the coating layer was immersed into the second coating liquid E for 3 seconds to allow the second coating liquid E in an amount of 10 g/m² to adhere onto the coating layer, and dried at 72° C. for 10 minutes, thereby producing an inkjet recording medium 1 of Example 1. The inkjet recording medium 1 had an ink receiving layer having a dry thickness of 35 μm.

“In-line liquid A”

| | | |
|---|---|---|
| (1) | Polyaluminum chloride aqueous solution (ALFINE 83, | 2.0 parts |
| | trade name, manufactured by Taimei Chemicals Co., | |
| | Ltd.; degree of basicity: 83%) | |
| (2) | Ion-exchange water | 8.0 parts |

### Example 2

An inkjet recording medium 2 was prepared in the same manner as in Example 1 except that PVA235 (trade name, manufactured by Kuraray Co., Ltd.; saponification degree: from 87 to 89%; polymerization degree: 3,500) was used as a polyvinyl alcohol in place of PVA217.

### Example 3

An inkjet recording medium 3 was prepared in the same manner as in Example 1 except that PVA124 (trade name, manufactured by Kuraray Co., Ltd.; saponification degree: from 98 to 99%; polymerization degree: 2,400) was used as a polyvinyl alcohol in place of PVA217.

### Example 4

An inkjet recording medium 4 was prepared in the same manner as in the preparation of the second coating liquid E of Example 1 except that the amount of the added polyvinyl alcohol was changed to 1 part.

### Example 5

An inkjet recording medium 5 was prepared in the same manner as in the preparation of the second coating liquid E of Example 1 except that the amount of the added polyvinyl alcohol was changed to 0.05 parts.

### Example 6

An inkjet recording medium 6 was prepared in the same manner as in Example 1 except that R1130 (trade name, manufactured by Kuraray Co., Ltd.; silanol-modified polyvinyl alcohol) was used as a polyvinyl alcohol in place of PVA217.

### Example 7

### Preparation of First Coating Liquid B

Similarly to the preparation of the first coating liquid A in Example 1, a first coating liquid B for ink receiving layer formation was prepared by adding 31.2 parts of the polyvinyl alcohol (water-soluble resin) solution A, 0.33 parts of boric acid, and 14.8 parts of ion-exchange water to 45.7 parts of the silica dispersion liquid A at 30° C. The mass ratio of the silica particles to the water-soluble resin (P/B ratio=silica particles/water-soluble resin) in the first coating liquid B was 4.1.

Preparation of First Coating Liquid C

Similarly to the preparation of the first coating liquid A in Example 1, a first coating liquid C for ink receiving layer formation was prepared by adding 20.8 parts of the polyvinyl alcohol (water-soluble resin) solution A, 0.33 parts of boric acid, and 25.2 parts of ion-exchange water to 45.7 parts of the silica dispersion liquid A at 30° C.

Production of Inkjet Recording Medium

The front surface of the substrate was subjected to a corona discharge treatment. Thereafter, a lower layer coating liquid and an upper layer coating liquid were subjected to simultaneous multilayer coating using an extrusion die coater, thereby forming coating layer; specifically, the lower layer coating liquid was obtained by in-line mixing of the first coating liquid B and the in-line liquid A, and the upper layer coating liquid was obtained by in-line mixing of the first coating liquid C and the in-line liquid A. The coating amount of the first coating liquid B was 133 ml/m², the coating amount of the in-line liquid A was 8.0 ml/m², the coating amount of the first coating liquid C was 57 ml/m², and the coating amount of the in-line liquid A was 3.4 ml/m².

Thereafter, the coating layer was dried using a hot air drier (at a wind speed of from 3 to m/sec 8 m/sec) at 90° C. (dew-point temperature of 5° C.) until the solid content concentration of the coating layer became 17%. Subsequently, the coating layer was dried (at a wind speed of from 3 m/sec to 8 m/sec) at 55° C. (dew-point temperature of 5° C.) so that the solid content concentration of the coating layer became 24%. During these processes, the drying rate of the coating layer was constant (the coating layer shows the phenomenon of constant-rate drying).

Immediately thereafter, the coating layer was immersed into the second coating liquid E used in Example 1 for 3 seconds to allow the second coating liquid in an amount of 10 g/m² adhere onto the coating layer, and dried at 72° C. for 10 minutes, thereby producing an inkjet recording medium 7. The inkjet recording medium 7 had an ink receiving layer having a dry thickness of 35 μm.

### Comparative Example 1

An inkjet recording medium C1 of Comparative Example 1 was produced in the same manner as in Example 1 except that the composition of the second coating liquid was changed to the following composition.

“Second coating liquid F”

| | | |
|---|---|---|
| (1) | Ammonium carbonate (first grade, manufactured | 5.0 parts |
| | by Kanto Kagaku) | |
| (2) | Ion-exchange water | 89.0 parts |
| (3) | Polyoxyethylene lauryl ether (10% aqueous solution, | 6.0 parts |
| | EMULGEN 109P, trade name, manufactured by | |
| | Kao Corporation; HLB value of 13.6) | |

### Comparative Example 2

An inkjet recording medium C2 of Comparative Example 2 was produced in the same manner as in Example 7 except that, when the first coating liquid B and the first coating liquid C were subjected to simultaneous multilayer coating, the first coating liquid B was used as the upper layer coating liquid, the first coating liquid C was used as the lower layer coating liquid, and the second coating liquid F of Comparative Example 1 was used as the second coating liquid.

### Comparative Example 3

An inkjet recording medium C3 of Comparative Example 3 was produced in the same manner as in Example 1 except that, in the preparation of the second coating liquid E, 0.5 parts of polyallylamine (PAA03, trade name, manufactured by Nitto Boseki Co., Ltd.) was used instead of the polyvinyl alcohol.

Evaluation

The inkjet recording media were evaluated for the following properties. The results are shown in Table 1.

Scratch Resistance

A sheet of black paper (CANADIAN, trade name, manufactured by Tokyo Paper MFG. Co., Ltd.) was placed on each inkjet recording medium sheet, and the surface of each inkjet recording medium sheet was rubbed with the black paper using a friction tester (manufactured by Shinto Scientific Co., Ltd.) with a load of 300 g applied thereto. Thereafter, the extent of scratch was observed with the eyes and evaluated according to the following criteria.

### Criteria

A: No scratch was visually observed.
B: Some scratches were observed, but the toughness of the inkjet recording medium was at a level at which almost no scratches are generated in ordinary use.
C: Generation of scratches was confirmed, but it was a tolerable level in ordinary use.
D: Severe scratches were observed, and the degree of scratching was at an intolerable level.

Glossiness

The glossiness was determined as a mirror gloss at 60° measured using a digital multi-angle gloss meter (UGV-50DP, trade name, manufactured by Suga Test Instruments Co., Ltd.), and was evaluated according to the following criteria.

### Criteria

A: 45 or more
B: from 35 to less than 45
C: from 30 to less than 35
D: Less than 30

Ink Absorbency

Each inkjet recording medium was left under conditions of a temperature of 23° C. and a relative humidity (RH) of 50% for one day and under conditions of a temperature of 23° C. and a relative humidity of 80% for one day, for moisture control. Thereafter, a black solid image was printed on each inkjet recording medium using an inkjet printer (PM-A 820, trade name, manufactured by Seiko Epson Corporation) equipped with a genuine ink set. Whether the ink overflowed or not was observed with eyes, and evaluated according to the following criteria.

### Criteria

A: Overflowing of the ink was not observed.
B: Slight overflowing of the ink was observed on the inkjet recording medium that had been left under the conditions of a temperature of 23° C. and a relative humidity of 80%, but it was a practically non-problematical level.
C: A certain degree of overflowing of the ink was observed, and it was a practically problematical level.
D: A large degree of overflowing of the ink was observed.

Print Density

Each inkjet recording medium was left under conditions of a temperature of 23° C. and a relative humidity (RH) of 50% for one day for moisture control. Thereafter, a black solid image was printed on each inkjet recording medium using an inkjet printer (PM-A 820, trade name, manufactured by Seiko Epson Corporation) equipped with a genuine ink set. Subsequently, print image density was measured using X-rite 310TR (manufactured by X-Rite Inc.) and evaluated according to the following criteria.

### Criteria

A: 2.5 or more
B: from 2.4 to less than 2.5
C: from 2.3 to less than 2.4
D: Less than 2.3

TABLE 1

| | | Second coating liquid | | | | | |
|---|---|---|---|---|---|---|---|
| | | | Amount of | | | | |
| | First coating | | applied | Evaluation | | | |
| | liquid | | polymer | Scratch | | Ink | |
| | P/B ratio | Polymer | (g/m²) | resistance | Glossiness | absorbency | Print density |
| Example 1 | 4.9 | PVA217 | 0.01 | B | B | A | A |
| Example 2 | 4.9 | PVA235 | 0.01 | A | A | B | B |
| Example 3 | 4.9 | PVA124 | 0.01 | A | A | A | C |
| Example 4 | 4.9 | PVA217 | 0.1 | A | A | B | B |
| Example 5 | 4.9 | PVA217 | 0.005 | C | C | A | A |
| Example 6 | 4.9 | R1130 | 0.01 | A | A | A | A |
| Example 7 | Upper layer: 6.2 | PVA235 | 0.01 | A | A | A | A |
| | Lower layer: 4.1 | | | | | | |
| Comparative | 4.9 | — | — | D | C | A | A |
| example 1 | | | | | | | |
| Comparative | Upper layer: 4.1 | — | — | C | B | C | D |
| example 2 | Lower layer: 6.2 | | | | | | |
| Comparative | 4.9 | PAA | 0.01 | D | B | B | A |
| example 3 | | | | | | | |

As shown in Table 1, the inkjet recording media produced by the method of producing an inkjet recording medium of the invention had excellent scratch resistance and were capable of printing images with high print densities. Furthermore, the inkjet recording media produced by the method of producing an inkjet recording medium of the invention had high glossiness and excellent ink absorbency.

According to the invention, a method of producing an inkjet recording medium having excellent scratch resistance, high print density, and high glossiness is provided.

Embodiments of the present invention include, but are not limited to, the following.

<1> A method of producing an inkjet recording medium, the method comprising forming an ink receiving layer, wherein the forming of an ink receiving layer comprises: forming a coating layer by applying at least one first coating liquid including inorganic particles and a water-soluble resin onto a substrate; and applying a second coating liquid including a polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol.

<2> The method of producing an inkjet recording medium according to <1>, wherein the polyvinyl alcohol included in the second coating liquid has a polymerization degree of from 1,000 to 3,500.

<3> The method of producing an inkjet recording medium according to <1> or <2>, wherein, in the application of the second coating liquid, the amount of the applied polyvinyl alcohol is from 0.002 g/m² to 0.1 g/m².

<4> The method of producing an inkjet recording medium according to any one of <1> to <3>, wherein the at least one first coating liquid includes at least two coating liquids, and a content ratio of the inorganic particles to the water-soluble resin (P/B ratio) in one of the at least two coating liquids that is applied at a position farthest from the substrate is larger by 1 or more than the content ratio of the inorganic particles to the water-soluble resin in another of the at least two coating liquids that is applied at a position closer to the substrate.

<5> The method of producing an inkjet recording medium according to any one of <1> to <4>, wherein the inorganic particles contained in at least one coating liquid of the at least one first coating liquid comprise at least one of silica particles, colloidal silica, alumina particles, or pseudoboehmite.

<6> The method of producing an inkjet recording medium according to any one of <1> to <5>, wherein the water-soluble resin contained in at least one coating liquid of the at least one first coating liquid comprises at least one of polyvinyl alcohol (PVA), a cation-modified polyvinyl alcohol, an anion-modified polyvinyl alcohol, a silanol-modified polyvinyl alcohol, polyvinyl acetal, a cellulose resin, a chitin, a chitosan, starch, polyethylene oxide (PEO), polypropylene oxide (PPO), polyvinyl ether (PVE), polyacrylamide (PAAM), polyvinylpyrrolidone (PVP), a polyacrylic acid salt, a maleic acid resin, an alginic acid salt, or a gelatin.

<7> The method of producing an inkjet recording medium according to <6>, wherein at least one coating liquid of the at least one first coating liquid further comprises at least one crosslinking agent selected from borax, boric acid, or a borate.

<8> The method of producing an inkjet recording medium according to any one of <1> to <7>, wherein at least one coating liquid of the at least one first coating liquid further comprises at least one water-soluble aluminum compound selected from aluminum chloride or a hydrate thereof, aluminum sulfate or a hydrate thereof, ammonium alum, or a basic polyaluminum hydroxide compound.

<9> The method of producing an inkjet recording medium according to any one of <1> to <8>, wherein at least one coating liquid of the at least one first coating liquid further comprises a zirconium compound.

<10> The method of producing an inkjet recording medium according to any one of <1> to <9>, wherein at least one coating liquid of the at least one first coating liquid further comprises a high-boiling organic solvent.

<11> The method of producing an inkjet recording medium according to any one of <1> to <10>, wherein at least one coating liquid of the at least one first coating liquid is prepared using, as a solvent, water, an organic solvent, or a mixture thereof.

<12> The method of producing an inkjet recording medium according to any one of <1> to <11>, wherein the second coating liquid has a pH of 7.5 or higher.

<13> The method of producing an inkjet recording medium according to any one of <1> to <12>, wherein the polyvinyl alcohol included in the second coating liquid has a saponification degree of from 88% to 99%.

<14> The method of producing an inkjet recording medium according to any one of <1> to <13>, further comprising, after the application of the second coating liquid, heating at from 40° C. to 180° C. for from 0.5 minutes to 30 minutes for drying and curing.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of producing an inkjet recording medium, the method comprising forming an ink receiving layer, wherein the forming of an ink receiving layer comprises:
forming a coating layer by applying at least one first coating liquid comprising inorganic particles and a water-soluble resin onto a substrate; and
applying a second coating liquid comprising a polyvinyl alcohol, either (1) at the same time as the application of the at least one first coating liquid or (2) during drying of the coating layer formed by the application of the at least one first coating liquid but before the coating layer exhibits falling-rate drying, wherein the content of inorganic particles in the second coating liquid is 50% by mass or less with respect to the polyvinyl alcohol.

2. The method of producing an inkjet recording medium according to claim 1, wherein the polyvinyl alcohol included in the second coating liquid has a polymerization degree of from 1,000 to 3,500.

3. The method of producing an inkjet recording medium according to claim 1, wherein, in the application of the second coating liquid, the amount of the applied polyvinyl alcohol is from 0.002 g/m² to 0.1 g/m².

4. The method of producing an inkjet recording medium according to claim 1, wherein the at least one first coating liquid includes at least two coating liquids, and a content ratio of the inorganic particles to the water-soluble resin (P/B ratio) in one of the at least two coating liquids that is applied at a position farthest from the substrate is larger by 1 or more than the content ratio of the inorganic particles to the water-soluble resin in another of the at least two coating liquids that is applied at a position closer to the substrate.

5. The method of producing an inkjet recording medium according to claim 1, wherein the inorganic particles contained in at least one coating liquid of the at least one first coating liquid comprise at least one of silica particles, colloidal silica, alumina particles, or pseudoboehmite.

6. The method of producing an inkjet recording medium according to claim 1, wherein the water-soluble resin contained in at least one coating liquid of the at least one first coating liquid comprises at least one of polyvinyl alcohol (PVA), a cation-modified polyvinyl alcohol, an anion-modified polyvinyl alcohol, a silanol-modified polyvinyl alcohol, polyvinyl acetal, a cellulose resin, a chitin, a chitosan, starch, polyethylene oxide (PEO), polypropylene oxide (PPO), polyvinyl ether (PVE), polyacrylamide (PAAM), polyvinylpyrrolidone (PVP), a polyacrylic acid salt, a maleic acid resin, an alginic acid salt, or a gelatin.

7. The method of producing an inkjet recording medium according to claim 6, wherein at least one coating liquid of the at least one first coating liquid further comprises at least one crosslinking agent selected from borax, boric acid, or a borate.

8. The method of producing an inkjet recording medium according to claim 1, wherein at least one coating liquid of the at least one first coating liquid further comprises at least one water-soluble aluminum compound selected from aluminum chloride or a hydrate thereof, aluminum sulfate or a hydrate thereof, ammonium alum, or a basic polyaluminum hydroxide compound.

9. The method of producing an inkjet recording medium according to claim 1, wherein at least one coating liquid of the at least one first coating liquid further comprises a zirconium compound.

10. The method of producing an inkjet recording medium according to claim 1, wherein at least one coating liquid of the at least one first coating liquid further comprises a high-boiling organic solvent.

11. The method of producing an inkjet recording medium according to claim 1, wherein at least one coating liquid of the at least one first coating liquid is prepared using, as a solvent, water, an organic solvent, or a mixture thereof.

12. The method of producing an inkjet recording medium according to claim 1, wherein the second coating liquid has a pH of 7.5 or higher.

13. The method of producing an inkjet recording medium according to claim 1, wherein the polyvinyl alcohol included in the second coating liquid has a saponification degree of from 88% to 99%.

14. The method of producing an inkjet recording medium according to claim 1, further comprising, after the application of the second coating liquid, heating at from 40° C. to 180° C. for from 0.5 minutes to 30 minutes for drying and curing.
